(19) United States
(12) Patent Application Publication
(10) Pub. No.: US 2016/0188665 A1
(43) Pub. Date: Jun. 30, 2016

(54) HELP SEEKING METHOD AND SERVER USING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: JUN LI, Shenzhen (CN); CHIH-SAN CHIANG, New Taipei (TW); FENG XIAO, Shenzhen (CN); ZHAO-PING ZHANG, Shenzhen (CN)

(21) Appl. No.: 14/735,796

(22) Filed: Jun. 10, 2015

(30) Foreign Application Priority Data
Dec. 29, 2014 (CN) 201410841440.X

(51) Int. Cl. G06F 17/30; G06F 9/44

(52) U.S. Cl. CPC G06F 17/30424; G06F 9/4446

(57) ABSTRACT

A help seeking method is provided. The method includes: receiving servable help information from a helper and help seeking information from a help seeker and stored them in at least one storage device of the server, the servable help information including servable help type, contact information and a current geographic position of the helper, and the help seeking information including needed help type, contact information and a current geographic position of the help seeker; searching servable help information stored in the storage device which is corresponding to the received help seeking information to determine a preliminary confirmed helper; sending the help seeking information to the preliminary confirmed helper; receiving feedback from the preliminary conformed helper; determining a finally confirmed helper based on the feedback; and sending the contact information and the current geographic position of one of the finally confirmed helper and the help seeker to the other.

### FIELD

The subject matter herein generally relates to a help seeking method and a server using same.

### BACKGROUND

If a person runs into trouble, he or she will ask someone for help. However, sometimes it may be hard to find a right person for help. Therefore, there is a need for a method for quickly finding a right person for help.

### BRIEF DESCRIPTION OF THE DRAWINGS

Implementations of the present technology will now be described, by way of example only, with reference to the attached figures.

FIG. 1 is a block diagram of an exemplary embodiment of an operation environment of a server with a help seeking system.

FIG. 2 is a block diagram of an exemplary embodiment of a seeking system.

FIG. 3 is a flowchart of an exemplary embodiment of a help seeking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

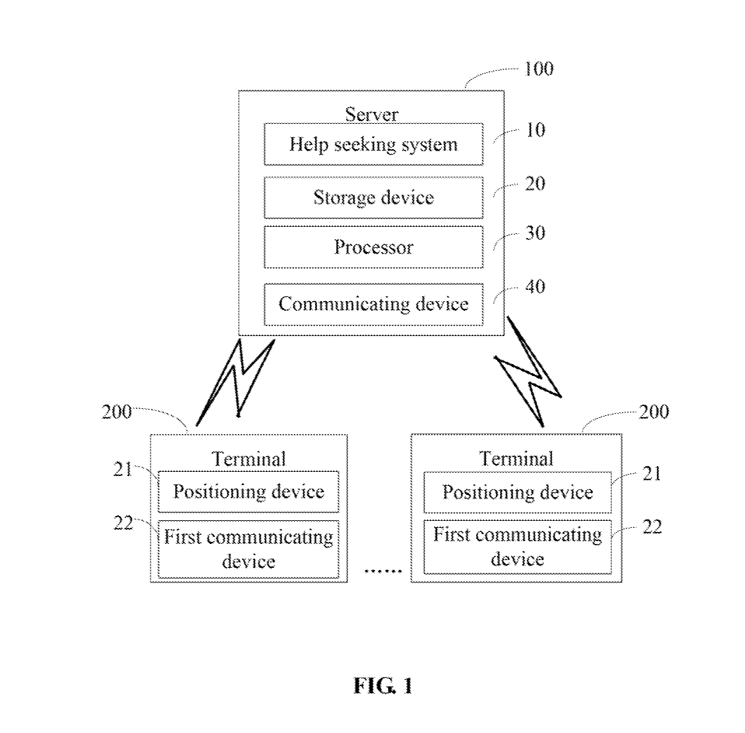

FIG. 1 illustrates a diagram of an exemplary embodiment of an operation environment of a server 100 with a help seeking system 10. In the example embodiment, the server 100 can communicates with one or more terminal devices 200 over networks. The server 100 can include, but not limited to, a storage device 20, a processor 30, and a first communicating device 40. The storage device 20 can be configured to store data related to operation of the server 100. The processor 30 can be configured to control operation of the server 100.

Each terminal device 200 can include a positioning device 21 and a second communicating device 22. The positioning device 21 can be configured to determine a current geographic position of the terminal device 200. The first communicating device 40 can communicate with the second communicating device 22 over networks.

In at least one embodiment, the networks can include, but not limited to, any conventional wired network, wireless network and the both. The wireless network can be any category of conventional wireless communications, for example, radio, Wireless Fidelity (WiFi), cellular, satellite, and broadcasting. Exemplary suitable wireless communication technologies comprise, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

The storage device 20 can be an internal storage unit of the server 100, for example, a hard disk or memory, or a pluggable memory, for example, Smart Media Card, Secure Digital Card, Flash Card. In at least one embodiment, the storage device 20 can include two or more storage devices such that one storage device is an internal storage unit and the other storage device is a pluggable memory. The processor 30 can be a central processing unit (CPU), a microprocessor, or other data processor chip that performs functions of the server 100.

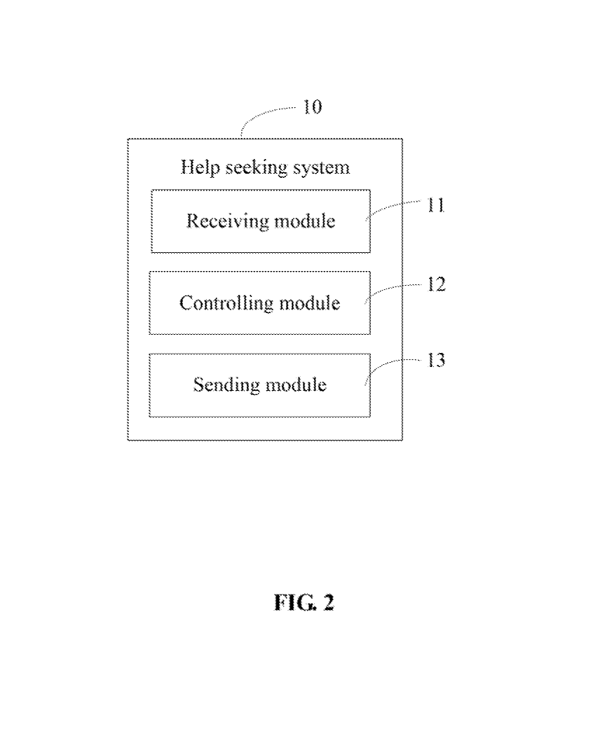

Referring to FIG. 2, the help seeking system 10 can include computerized instructions in the form of one or more programs that can be executed by the processor 30. In the embodiment, the help seeking system 10 can be integrated in the processor 30. In at least one embodiment, the help seeking system 10 can be independent from the processor 30 and can be stored in the storage device 20 and coupled to the processor 30. Referring to FIG. 1, the system 10 can include one or more modules, for example, a receiving module 11, a controlling module 12, and a sending module 13. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 11 can be configured to receive servable help information from a helper and to receive help seeking information from a help seeker. The controlling module 12 can be configured to search in the storage device for servable help information corresponding to the help seeking information and to determine a preliminary confirmed helper based on a pre-defined rule or a selection of the help seeker. The sending module 13 can be configured to send the help seeking information to the preliminary confirmed helper. The controlling module further configured to receive feedback from the preliminary confirmed helper and determine a finally confirmed helper based on the feedback. The sending module further configured to send contact information of one of the finally confirmed helper and the help seeker to the other. The servable help information can include, but not limited to: servable help type, service scope, service area range, contact information and a current geographic position of the helper. In at least one embodiment, the servable help information can further include, but not limited to, evaluation by other help seeker, response times, service scope, and service attitude of the helper. The help seeking information can include, but not limited to, service times of the help seeker, service scope of the help seeker, times of help seeking, needed help type, and evaluation of the help seeker provided by other helpers

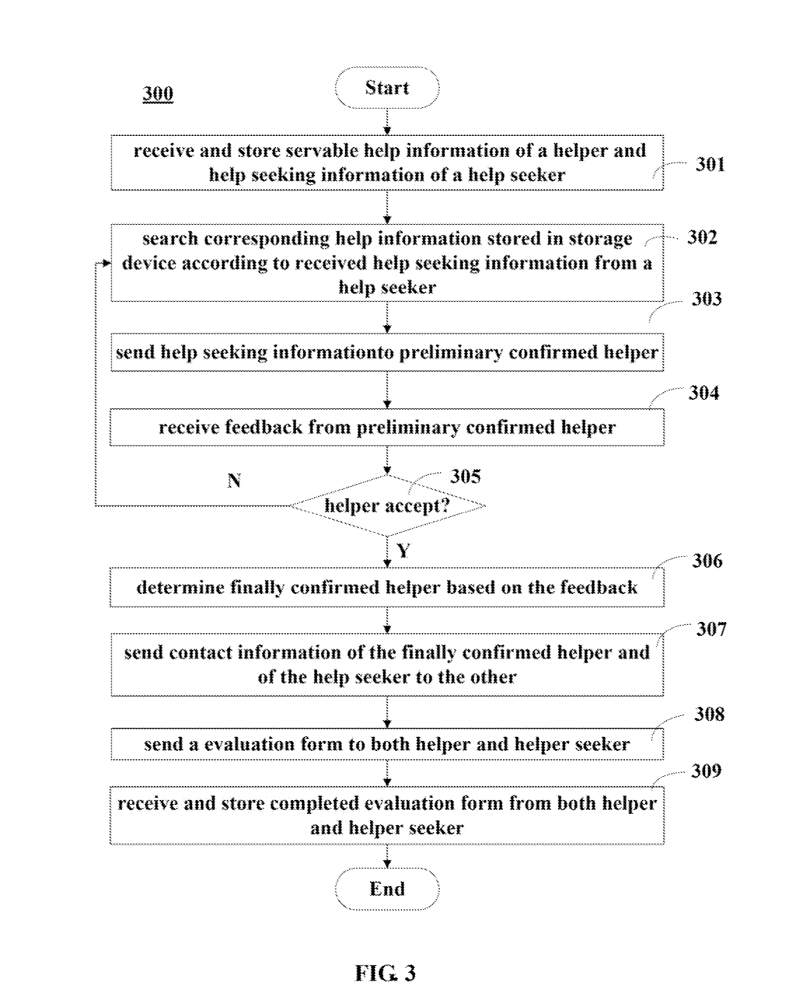

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of the figure is referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary help seeking method 300 is illustrated in FIG. 3. The exemplary method 300 can be executed by a server, and can begin at block 301. The server can include a first communicating device configured to communicate with a second communicating device of a terminal device, and a storage device configured to store related information.

At block 301, the server receives servable help information from a terminal device of a helper and help seeking information from a terminal device of a help seeker. The received information is then stored into the storage device. The servable help information can include, but not limited to, servable help type, a geographic position, contact information and service area range of the helper. The help seeking information can include, but not limited to, needed help type, service area range of the needed help, a geographic position and contact information of the help seeker. The contact information can include, but not limited to, a cell phone number, a QQ® number, a WeChat® ID, and an E-mail address. In at least one embodiment, the terminal device can include a positioning device configured to determine a current position of the terminal device. Both the servable help information and the help seeking information can be sent from the second communicating device to the first communicating device over a network. In at least one embodiment, the networks can include, but not limited to, any conventional wired network, wireless network and the both. The wireless network can be any category of conventional wireless communications, for example, radio, Wireless Fidelity (WiFi), cellular, satellite, and broadcasting. Exemplary suitable wireless communication technologies comprise, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

At block 302, the server searches in the storage device to determine servable help information corresponding to a received help seeking information. The server determines at least one preliminary confirmed helper based on the servable help information corresponding to the received help seeking information. In the exemplary embodiment, the server determines the at least one preliminary confirmed helper based on a pre-defined rule. The pre-defined rule can include at least one of: choosing a helper with the shortest distance between the helper and the help seeker, choosing a highest reputation helper, choosing a helper with highest response times, and choosing a helper with most perfect service. In at least one exemplary embodiment, the server can push the corresponding servable help information to the terminal device of the help seeker. The help seeker can select one or more preliminary confirmed helper manually. The server determines the preliminary confirmed helper based on the selection of the help seeker.

At block 303, the server sends the help seeking information to the preliminary confirmed helper. In at least one embodiment, the help seeking information can include at least one of: service times of the help seeker, service scope of the help seeker, times of help seeking, needed help type, and evaluation of the help seeker provided by other helpers.

At block 304, the server receives feedback from the preliminary confirmed helper.

At block 305, the server determines whether the preliminary confirmed helper accepts to provide service to the help seeker based on the feedback.

At block 306, the server determines a finally confirmed helper based on the feedback from the preliminary confirmed helper if the help seeker accepts to provide service to the help seeker. Otherwise, the process goes back to block 302 if the help seeker refuse to provide service to the help seeker. In at least one embodiment, if a number of the preliminary confirmed helper who accepts to provide service to the help seeker is more than one, the server can push all the preliminary confirmed helper who accepts to provide service to the help seeker to the terminal device of the help seeker to select a finally confirmed helper.

At block 307, the server sends contact information of the final confirmed helper to the terminal device of the help seeker. In at least one embodiment, the server can generate navigation information based on the current geographic positions of the finally confirmed helper and the help seeker and can provide the navigation information to at least one of the finally confirmed helper and helper seeker.

At block 308, the server sends a blank evaluation form to both the finally confirmed helper and the help seeker after the needed help is served. The blank evaluation form can include at least one of: service attitude, service scope, quality of service.

At block 309, the server receives a filled evaluation form from each one of the finally confirmed helper and the help seeker and then stores the filled evaluation form into the storage device of the server.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A help seeking method, comprising:
receiving, at a server, servable help information, the servable help information includes servable help type, contact information and a current geographic position of a helper, and the help seeking information includes needed help type, contact information and a current geographic position of a help seeker;
searching, at the server, servable help information stored in a storage device corresponding to the received help seeking information to determine a preliminary confirmed helper;
sending, at the server, the help seeking information to the preliminary confirmed helper;
receiving, at the server, feedback from the preliminary confirmed helper;
determining, at the server, a finally confirmed helper in response to the feedback; and
sending, at the server, the contact information and the current geographic position of the finally confirmed helper and the help seeker.

2. The method according to claim 1, wherein the severable help information includes service area range of the helper.

3. The method according to claim 1, wherein the help seeking information includes service area range of the needed help of the help seeker.

4. The method according to claim 1, further comprising:
sending an evaluation form to each of the finally confirmed helper and the help seeker; and
receiving a completed evaluation form from the finally confirmed helper and the help seeker and storing the filled evaluation form into the storage device of the server.

5. The method according to claim 1, further comprising:
generating, at the server, navigation information based on the current geographic positions of the finally confirmed helper and the help seeker; and
sending, at the server, the navigation information to the finally confirmed helper and the help seeker.

6. The method according to claim 1, further comprising:
determining, at the server, the preliminary confirmed helper based on a pre-defined rule, wherein the pre-defined rule comprises at least one of: choosing a helper with the shortest distance between the helper and the help seeker, choosing a highest reputation helper, choosing a helper with highest response times, and choosing a helper with most perfect service.

7. The method according to claim 1, further comprising:
sending, at the server, the searched servable help information corresponding to the help seeking information to the help seeker; and
determining, at the server, the preliminary confirmed helper based on a selection of the help seeker.

8. A server, comprising:
a storage device configured to store instructions; and
a processor configured to execute instructions to cause the processor to:
search servable help information stored in the storage device which is corresponding to the received help seeking information to determine a preliminary confirmed helper; and
send the help seeking information to the preliminary confirmed helper to inquire whether the preliminary confirmed helper agrees to provide help to the help seeker;
receive feedback from the preliminary conformed helper;
determine a finally confirmed helper in response to the feedback; and
send the contact information and the current geographic position of one of the finally confirmed helper and the help seeker to the other.

9. The server according to claim 8, wherein the severable help information comprises service area range of the helper.

10. The server according to claim 8, wherein the help seeking information comprises service area range of the needed help of the help seeker.

11. The server according to claim 8, wherein the instructions cause the processor to:
send a blank evaluation form to each of the finally confirmed helper and the help seeker; and
receive a filled evaluation form from each of the finally confirmed helper and the help seeker and storing the filled evaluation form into the storage device of the server.

12. The server according to claim 8, further comprising:
generate navigation information based on the current geographic positions of the finally confirmed helper and the help seeker; and
send the navigation information to at least one of the finally confirmed helper and the help seeker.

13. The server according to claim 8, wherein said determining the preliminary confirmed helper comprises:
determine the preliminary confirmed helper based on a pre-defined rule, wherein the pre-defined rule comprises at least one of: choosing a helper with the shortest distance between the helper and the help seeker, choosing a highest reputation helper, choosing a helper with highest response times, and choosing a helper with most perfect service.

14. The server according to claim 8, wherein said determining the preliminary confirmed information comprises:
send searched servable help information corresponding to the help seeking information to the help seeker; and
determine the preliminary confirmed helper based on a selection of the help seeker.
